(19) United States
(12) Patent Application Publication
(10) Pub. No.: US 2024/0174543 A1
(43) Pub. Date: May 30, 2024

(54) SYSTEMS AND METHODS FOR FABRICATING RING STRUCTURES

(71) Applicant: CORNING INCORPORATED, Corning, NY (US)

(72) Inventor: Maximilian Joachim Gustav Breitwieser, Munich (DE)

(21) Appl. No.: 18/385,554

(22) Filed: Oct. 31, 2023

Related U.S. Application Data
(60) Provisional application No. 63/385,531, filed on Nov. 30, 2022.

(51) Int. Cl. C03B 33/02; B23K 26/53; C03B 33/10

(52) U.S. Cl. CPC C03B 33/0222; B23K 26/53; C03B 33/102; B23K 2103/54

(57) ABSTRACT

Systems and methods for fabricating ring structures are disclosed. In one embodiment, a method of forming a ring structure includes forming an inner contour and an outer contour including a plurality of perforations by directing a pulsed laser beam focal line into a substrate at a plurality of locations, the pulsed laser beam focal line generating an induced absorption within a substrate at each of the locations, the induced absorption producing one of the plurality of perforations. The method further includes heating the outer contour with a heating laser beam such that an article separates from the substrate at the outer contour, heating a region of the article between an outer edge of the article and the inner contour with the heating laser beam, and removing an inner portion of the article at the inner contour to form the ring structure.

This application claims the benefit of priority under 35 U.S.C § 120 of U.S. Provisional Application Ser. No. 63/385,531 filed on Nov. 30, 2022, the content of which is relied upon and incorporated herein by reference in its entirety.

### BACKGROUND

Ring structures fabricated from a substrate, such as glass, may be desired in applications such as electronics, robotics, and wireless communications. Prior methods of fabricating ring structures are undesirable because of low yield, rough edges, slow processing times, and high costs.

Accordingly, alternative systems and methods for fabricating ring structures may be desired.

### SUMMARY

Various embodiments of systems and methods for fabricating glass, glass-ceramic, or ceramic ring structures from a base substrate. More particularly, embodiments of the present disclosure provide a ring cutting process to create glass rings that combines a laser perforation process and a heating laser process.

In one embodiment, a method of forming a ring structure includes forming an inner contour and an outer contour including a plurality of perforations by directing a pulsed laser beam focal line into a substrate at a plurality of locations, the pulsed laser beam focal line generating an induced absorption within the substrate at each of the locations, the induced absorption producing one of the plurality of perforations. The method further includes heating the outer contour with a heating laser beam such that an article separates from the substrate at the outer contour, heating a region of the article between an outer edge of the article and the inner contour with the heating laser beam, and removing an inner portion of the article at the inner contour to form the ring structure.

In another embodiment, a system for forming a ring structure includes a carrier having a surface for receiving a substrate, an actuator for translating the carrier in at least two directions, a perforation laser assembly comprising a perforation laser and at least one lens, a heating laser beam assembly comprising a heating laser and at least one focusing lens, and a controller programmed to control the actuator, the perforation laser, and the heating laser to form an inner contour and an outer contour including a plurality of perforations by directing a pulsed laser beam focal line into a substrate at a plurality of locations, the pulsed laser beam focal line generating an induced absorption within the substrate at each of the locations, the induced absorption producing one of the plurality of perforations, and heat the outer contour with a heating laser beam such that an article separates from the substrate at the outer contour, and heat a region of the article between an outer edge of the article and the inner contour with the heating laser beam such that an inner portion of the article is removable at the inner contour to form the ring structure.

### BRIEF DESCRIPTION OF THE FIGURES

FIG. 1 illustrates an example ring structure according to one or more embodiments described and illustrated herein.

FIG. 2A illustrates an example substrate having a ring defined by an inner contour and an outer contour formed therein according to one or more embodiments described and illustrated herein.

FIG. 2B illustrates another example substrate having a ring defined by an inner contour and an outer contour formed therein according to one or more embodiments described and illustrated herein.

FIG. 3 illustrates an example system for forming inner and outer contours in a substrate according to one or more embodiments described and illustrated herein.

FIG. 4A illustrates an example article separated from the substrate shown in FIG. 2A according to one or more embodiments described and illustrated herein.

FIG. 4B illustrates another example article separated from the substrate shown in FIG. 2A according to one or more embodiments described and illustrated herein.

FIG. 5 illustrates a system for heating an article for removing an inner portion and forming a ring structure according to one or more embodiments described and illustrated herein.

FIG. 6 illustrates a flowchart of an example method for forming a ring structure according to one or more embodiments described and illustrated herein.

### DETAILED DESCRIPTION

References will now be made in detail to the embodiments of the disclosure, examples of which are illustrated in the accompanying drawings. Whenever possible, like reference numbers will be used to refer to like components or parts.

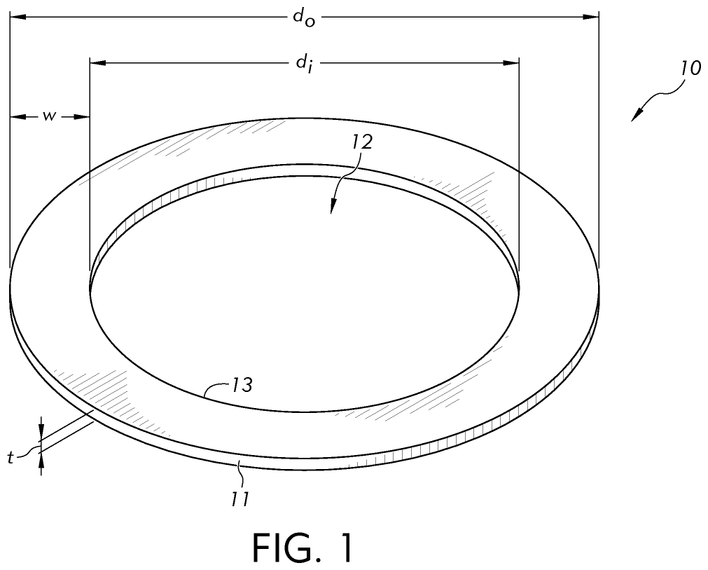

There is a need for glass ring structures (as well as glass-ceramic and ceramic ring structures) where the outer diameter is not much larger than the inner diameter, which results in a ring shape rather than disk with a hole. FIG. 1 illustrates such an example ring structure 10. These ring structures may be used in many applications, such as electronics, robotic, and wireless communications applications.

The example ring structure 10 has an outer edge 11 defining an outer diameter dₒ, and an inner edge 13 defining an inner diameter dᵢ, such that dₒ>dᵢ. The outer diameter dₒ and the inner diameter dᵢ dictate a width w of the ring structure 10. The ring structure 10 further includes an open region 12 and a thickness t.

Previous methods for fabricating a ring structure from a substrate are undesirable. For example, an ablative process uses a high-powered laser to ablate and physically remove substrate material along a contour defining the inner diameter and the outer diameter. This process therefore physically cuts the ring structure from the substrate. However, this process results in poor edge quality (i.e., high side wall roughness and edge chipping) and has a slow processing time. As another example, a drop-out process requires heating an inner waste portion of the ring structure that will become the open region. Heating this inner waste portion causes it to deform and drop out to form the open region of the ring structure. However, the required temperature for the drop-out process is high, and the drop-out process is limited with respect to the maximum diameter of the open region and the thickness of the substrate. In some cases, the thickness of the substrate is too high and/or the width w of the ring is too small to drop out the inner waste portion without bursting the surrounding ring shape.

As described in more detail below, the ring structure 10 is fabricated from a base substrate by an initial laser perforation operation that defines the contours of the ring structure 10 within the substrate, followed by heating of the outer contour perforation line by a CO₂ laser (or other heating laser) to separate an article (with a circular or other shape defined by the outer contour) within the outer contour from the substrate, and then heating of the article by the CO₂ laser to remove the inner portion of the article (defined by the inner contour) to create the ring structure. Thus, in embodiments of the present disclosure, it is the ring shape that is heated rather than the inner waste portion as occurs in the drop-out process. This results in the ability to process ring structures having a higher thickness t (e.g., 1.0 mm-5.0 mm) and a smaller width w (e.g., 3 mm to 25 mm) than was achievable by previous processing methods.

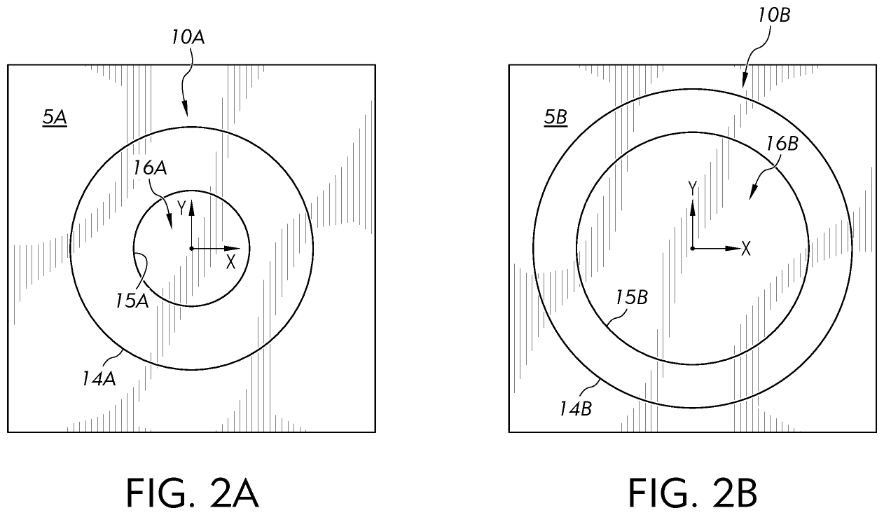

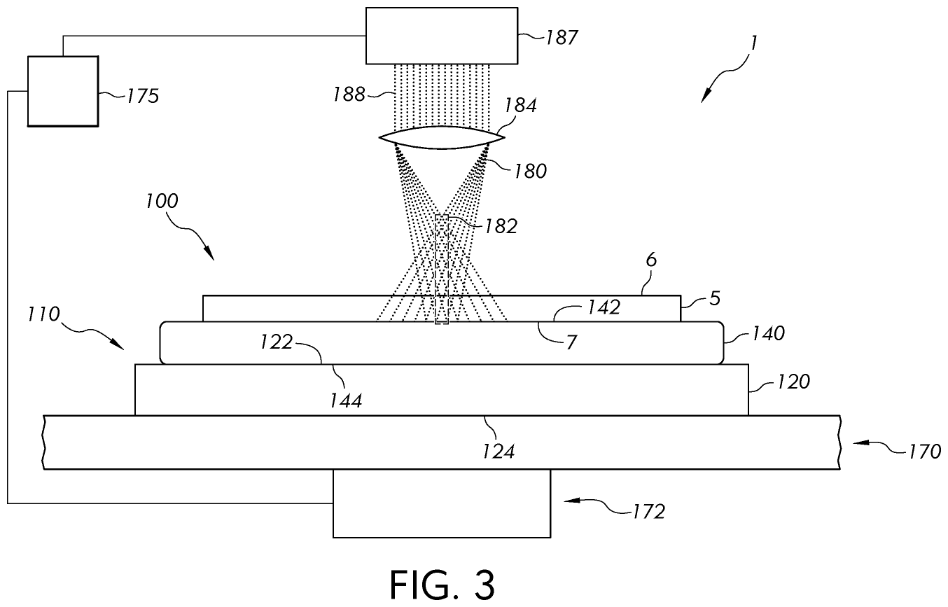

FIGS. 2A and 2B illustrates two glass substrates 5A and 5B each having a ring structure 10A, 10B, respectively, defined by laser-induced perforation lines. The substrate 5A, 5B may be any material substantially transparent to the electromagnetic radiation of the laser beam 180 (FIG. 3) that forms the perforation lines that define the inner contour and the outer contour. For example, the substrate 5A, 5B may be, without limitation, glass, sapphire, silicon, silicon carbide (SiC), quartz, alumina (Al₂O₃), aluminum nitride (AIN), Zirconia (ZrO₂), gallium nitride (GaN), gallium arsenide (GaAs), gallium phosphide (GaP), gallium antimonide (GaSb), indium arsenide (InAs), indium phosphide (InP), indium antimonide (InSb), cadmium sulphide (CdS), cadmium selenide (CdSe), cadmium telluride (CdTe), zinc sulfide (ZnS), zinc selenide (ZnSe), zinc telluride (ZnTe), germanium (Ge), lithium niobate (LiNbO₃), lithium tantalate (LiTaO₃), or combinations thereof. The substrate 5A, 5B may have a substantially flat top surface and a substantially flat bottom surface, such as would be suitable for cover glass for an electronic device. The top surface 162 and/or the bottom surface 164 may be polished. In another embodiment, the substrate 5A, 5B may be a wafer material for semiconductor manufacturing. If glass is utilized as the substrate 5A, 5B, the glass may generally be any glass suitable for formation as a sheet. In some embodiments, the glass may be ion-exchangeable aluminosilicate glass. Examples of such ion-exchangeable aluminosilicate glass include, but are not limited to, Gorilla Glass® and Gorilla Glass II® (commercially available from Corning, Inc.). Such glass, especially after laser processing, may be well suited for many uses, such as, for example, as cover glass for hand-held consumer electronic devices. Other glasses include silicates, borosilicates, aluminoborosilicates, phosphates, including modified variants thereof (e.g., doped with alkali or alkaline earth oxides).

Each ring structure 10A, 10B has an inner contour 15A, 15B and an outer contour 14A, 14B. The ratio of the diameter of the outer contour 14A to the diameter of the inner contour 15A for the ring structure 10A of FIG. 2A is 2.1. The ratio of the diameter of the outer contour 14B to the diameter of the inner contour 15B for the ring structure 10B of FIG. 2B is 1.4. Ring structure 10A, 10B were created from a glass substrate 5A having a thickness of 1.6 mm (FIG. 2A) and a glass substrate 5B having a thickness of 3.1 mm (FIG. 2B), respectively.

In a first step, the inner contour 15A, 15B and the outer contour 14A, 14B are formed by a laser perforation process whereby microscopic damage features referred to as perforations are formed through the bulk of the substrate 5A, 5B. These perforations may include cracks, defects, compactions, or other structural modifications induced by the laser 180. In a preferred embodiment, perforations are formed through non-linear absorption by the substrate of the wavelength of the laser 180. In another preferred embodiment, ablation of the substrate does not occur upon formation of the perforations and the perforations are formed through modification of the structure of the region defining the perforation relative to the structure of the unmodified region surrounding the perforation. Thus, a laser can be used to create highly controlled perforations through all or part of the thickness of the material, with extremely little (<75 μm, often <50 μm) subsurface damage and debris generation. Accordingly, it is possible to create microscopic perforations (i.e., <0.5 μm and >100 nm in diameter) in the substrate using a single high energy laser pulse, preferably a burst pulse. These individual perforations can be created at rates of several hundred kilohertz (several hundred thousand perforations per second, for example). Thus, with relative motion between the laser source and the substrate, these perforations can be placed adjacent to one another (spatial separation varying from sub-micron to several microns as desired). This spatial separation is selected in order to facilitate cutting.

In some embodiments the defect line is a “through hole”, which is a hole or an open channel that extends from the top to the bottom of the transparent material. In some embodiments the defect line may not be a continuous channel and may be blocked or partially blocked by portions or sections of solid material (e.g., glass). As defined herein, the internal diameter of the defect line is the diameter of the structurally modified region. For example, in the embodiments described herein the internal diameter of the defect line is <500 nm, for example ≤400 nm, or ≤300 nm. The disrupted or modified area (e.g., compacted, melted, or otherwise structurally altered area) of the material surrounding the modified areas in the embodiments disclosed herein, preferably has diameter of <50 μm (e.g., <10 μm).

Referring to FIG. 3, a non-limiting, example system 1 for forming an inner contour 15A, 15B and an outer contour 14A, 14B defined by a plurality of perforations is illustrated. The system 1 generally includes a multilayer stack 100 comprising a substrate 5 and a carrier 110 which includes a laser disruption element 140 and a support base 120. In embodiments described herein, the substrate 5 is positioned on top of the laser disruption element 140, which is positioned on top of the support base 120. In other embodiments, no laser disruption element 140 is provided and the substrate 5 is disposed directly on the support base 120 or some other intermediate layer. As used herein, reference to a position above or on top of another position assumes that the top or uppermost position is the surface of the multilayer stack 100 upon which a laser beam 180 produced by a laser source 187 is first incident. For example, in FIG. 3, the surface of the substrate 5 that is closest to the source laser 188 is the top surface 6 and placement of the laser disruption element 140 below the substrate 5 means that the laser beam 180 traverses the substrate 5 before interacting with the laser disruption element 140 (or support base 120 or other layer if no laser disruption element 140 is provided). As shown in FIG. 3, the laser light 188 is transmitted through an optical element 184 which forms a focused area of the laser beam 180, such as a focal line 182 in the form of a Bessel beam, which is incident upon the substrate 5 at top surface 6. The laser source 187 and the optical element 184 define a perforation laser assembly.

One or more controllers 175 configured to provide control signals to the one or more actuators 172 and the laser source 187 are included to control the one or more actuators 172 and the laser source 187. The one or more controllers 175 can control operation of the laser source 187 and/or relative motion of focused laser beam 180 and substrate 5.

The substrate 5 may be laser processed with a laser beam 180 which may alone, or with other manufacturing steps, be utilized to modify the substrate 5. As used herein, laser processing refers to perforating otherwise altering the mechanical or structural integrity of a material with a laser beam 180. Generally, the laser beam 180 has a certain intensity at a particular area of the substrate 5 to alter the mechanical or structural integrity of the substrate 5. As such, a defocused or disrupted laser beam may not have sufficient intensity to mechanically or structurally affect a material to form a perforation at a selected area while a focused laser beam may have sufficient intensity to perforate an area of a laser processed material. However, a focused area of a laser beam, such as a laser beam with a focal line 182, may have sufficient intensity to perforate the substrate 5 as well as to damage a support base 120 directly contacted by the focal line 182. A focal line 182 of a laser beam 180 may be produced by an optical element 184 (e.g., an axicon, diffractive optical element, phase plate) which can optically alter the intensity or path of a laser light 188 produced by laser source 187. Also, as used herein, in the context of laser beams, “intensity” may be referred to as “energy density” and the two terms are interchangeable. The laser beam 180 has a wavelength, and as used herein, a material that is “transparent” is substantially transparent to electromagnetic radiation of the wavelength of the laser such that the absorption by the substrate 5 is less than about 10%, less than about 5%, or even less than about 1% per mm of material depth at the wavelength of the laser. “Electromagnetic radiation” may be referred to herein as “light” and the two terms are interchangeable and may correspond with electromagnetic radiation both inside and outside of the visible spectrum.

Generally, the laser disruption element 140 optically disrupts a laser beam 180 transmitted through the substrate 5 such that the laser beam 180 does not have sufficient intensity (i.e., at the focal line 182) below the laser disruption element 140 to damage the support base 120. For example, optical disruption may include reflection, absorption, scattering, defocusing or otherwise interfering with the laser beam 180. The disruption element 140 may reflect, absorb, scatter, defocus or otherwise interfere with an incident laser beam 180 to inhibit or prevent the laser beam 180 from damaging or otherwise modifying underlying layers in the multilayer stack 100, such as the support base 120.

The support base 120 is generally any structure capable of supporting the substrate 5 which will be laser processed by the laser beam 180. The support base 120 may act as a carrying tray for the substrate 5 and may have a substantially flat top surface 122, for interaction with a flat substrate 5, and a substantially flat bottom surface 124, for interaction with a substantially flat worktable 170 upon which the support base 120 may be positioned. The worktable 170 may be an indexing table having one or more actuators 172 for translating the worktable 170 in at least two directions. In other embodiments, the source laser 187 and/or the optical element 184 translates to provide relative movement between the laser beam 180 and the substrate 5.

The support base 120 may comprise aluminum. For example, the support base 120 may comprise greater than about 50%, greater than about 70%, greater than about 90%, greater than about 95%, or even greater than about 99% aluminum. In one embodiment, the support base 120 may comprise a honeycomb aluminum structure, such as ALUCORE®, commercially available from 3A Composites International AG. In another embodiment, the support base 120 may comprise polyoxmethylene. If non-transparent materials, such as the materials of the support base 120, are contacted by the focal line 182, the support base 120 can be damaged, which may result in contamination of the laser processed substrate 5. As used herein, damage to the support base 120 includes, without limitation scratching, ablating, cutting, slashing, abrasion, scoring, or other disruption in the mechanical integrity of the top surface 122 of the support base 120.

In some embodiments, the support base 120 may be placed on a table or other workstation during the laser processing. The table or workstation may have a vacuum system which creates suction upon the surface of the table or workstation. For example, the table or workstation may have vacuum holes in its surface, and the support base 120 and laser disruption element 140 may have corresponding holes through which the vacuum may create suction and secure materials positioned on top of the laser disruption element 140. For example, the substrate 5 may be secured to the disruption element 140 by vacuum suction which permeates through holes in the laser disruption element 140, support base 120, and workstation. The support base 120 and the laser disruption element 140 may be mechanically fastened to one another such as with screws, fasteners, pins, or other suitable means. As such, the substrate 5 can rest upon the laser disruption element 140 and be secured by the vacuum system while laser processed.

The selection of the source laser 187 is predicated on the ability to induce multi-photon absorption (MPA) in the substrate 5. MPA is the simultaneous absorption of multiple photons of identical or different frequencies in order to excite a material from a lower energy state (usually the ground state) to a higher energy state (excited state). The excited state may be an excited electronic state or an ionized state. The energy difference between the higher and lower energy states of the material is equal to the sum of the energies of the two photons. MPA is a third-order nonlinear process that is several orders of magnitude weaker than linear absorption. It differs from linear absorption in that the strength of absorption depends on the square of the light intensity, thus making it a nonlinear optical process. At ordinary light intensities, MPA is negligible. If the light intensity (energy density) is sufficiently high, such as in the region of focus of a source laser (particularly a pulsed source laser), MPA becomes appreciable and leads to measurable effects in the material within the region where the energy density of the light source is sufficiently high. Within the focal region, the energy density may be sufficiently high to result in ionization.

At the atomic level, the ionization of individual atoms has discrete energy requirements. Several elements commonly used in glass (e.g., Si, Na, K) have relatively low ionization energies (˜5 eV). Without the phenomenon of MPA, a wavelength of about 248 nm would be required to create linear ionization at ˜5 eV. With MPA, ionization or excitation between states separated in energy by ˜5 eV can be accomplished with wavelengths longer than 248 nm. For example, photons with a wavelength of 532 nm have an energy of ˜2.33 eV, so two photons with wavelength 532 nm can induce a transition between states separated in energy by ˜4.66 eV in two-photon absorption (TPA), for example.

Thus, atoms and bonds can be selectively excited or ionized in the regions of a material where the energy density of the laser beam is sufficiently high to induce nonlinear TPA of a laser wavelength having half the required excitation energy, for example. MPA can result in a local reconfiguration and separation of the excited atoms or bonds from adjacent atoms or bonds. The resulting modification in the bonding or configuration can result in non-thermal ablation and removal of matter from the region of the material in which MPA occurs. This removal of matter creates a structural defect (e.g., a defect line or “perforation”) that mechanically weakens the material and renders it more susceptible to cracking or fracturing upon application of mechanical or thermal stress. By controlling the placement of perforations, a contour or path along which cracking occurs can be precisely defined and precise micromachining of the material can be accomplished. The contour defined by a series of perforations may be regarded as a fault line and corresponds to a region of structural weakness in the material. In one embodiment, micromachining includes separation of a part from the material processed by the laser, where the part has a precisely defined shape or perimeter determined by a closed contour of perforations formed through MPA effects induced by the laser. As used herein, the term closed contour refers to a perforation path formed by the laser line, where the path intersects with itself at some location. An internal contour is a path formed where the resulting shape is entirely surrounded by an outer portion of material. In a preferred embodiment, the inner contour (e.g., 15A, 15B) and outer contour (e.g., 14A, 14B) are closed contours.

Perforations can be accomplished with a single “burst” of high energy short duration pulses spaced close together in time. As non-limiting examples, the laser pulse duration may be 10⁻¹⁰ s or less, or 10⁻¹¹ s or less, or 10⁻¹² s or less, or 10⁻¹³ s or less. These “bursts” may be repeated at high repetition rates (e.g., kHz or MHz). The perforations may be spaced apart and precisely positioned by controlling the velocity of a substrate relative to the laser through control of the motion of the laser and/or the substrate.

As a non-limiting example, in a thin transparent substrate moving at 200 mm/sec exposed to a 100 KHz series of pulses, the individual pulses would be spaced 2 μm apart to create a series of perforations separated by 2 μm. This defect (perforation) spacing is sufficiently close to allow for thermal separation along the contour defined by the series of perforations. In other embodiments, the relative speed of motion of the substrate and laser and/or laser repetition rate may be controlled to adjust the spacing between perforations to be in a range from 1.0 μm to 50 μm, or in a range from 2.0 μm to 40 μm in a range from 3.0 μm to 30 μm, or in a range from 4.0 μm to 25 μm, or in a range from 5.0 μm to 20 μm.

Referring once again to FIGS. 2A and 2B, the perforations define the inner contour 15A, 15B and the outer contour 14A, 14B of a first glass substrate 5A and a second glass substrate 5B, respectively. The material within the portion between the inner contour 15A, 15B, and the outer contour 14A, 14B define the ring structure that will be separated from the first glass substrate 5A and the second glass substrate 5B during a separation process that is described below. Although FIGS. 2A and 2B illustrate a circular ring structure, embodiments are not limited thereto. The ring structure that is formed may take on other shapes, such as, without limitation, an elliptical, oval, non-circular, rectilinear, polygonal, trapezoidal, square, or rectangular outer contour shape.

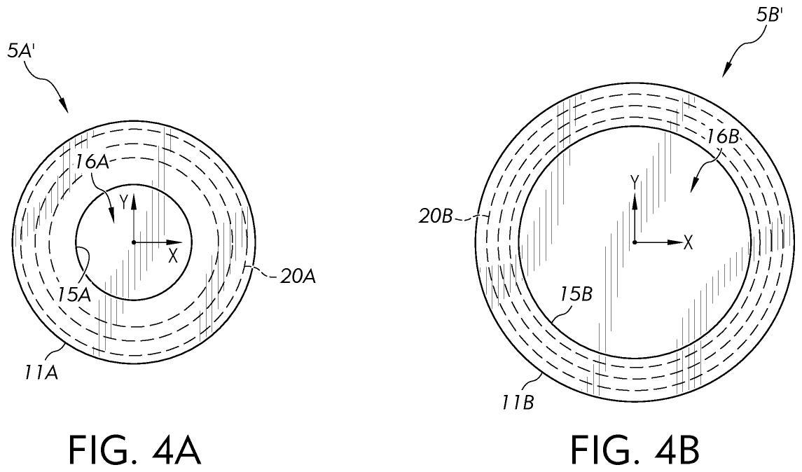

Next, the interior portion of the substrate 5A, 5B within the outer contour 14A, 14B is removed by heating the outer contour 14A, 14B using a CO₂ laser or other suitable heating laser. The heat from the laser causes cracking along the perforations of the outer contour 14A, 14B. The causes the portion of the substrate 5A, 5B within the outer contour 14A, 14B to drop out. The perforations weaken the substrate 5A, 5B and cause preferential cracking along the outer contour 14A, 14B when exposed to a CO₂ laser or other heating laser. This results in a detached article 5A′, 5B′ (circular or other shape) having the inner contour 15A, 15B remaining therein, as shown in FIGS. 4A and 4B.

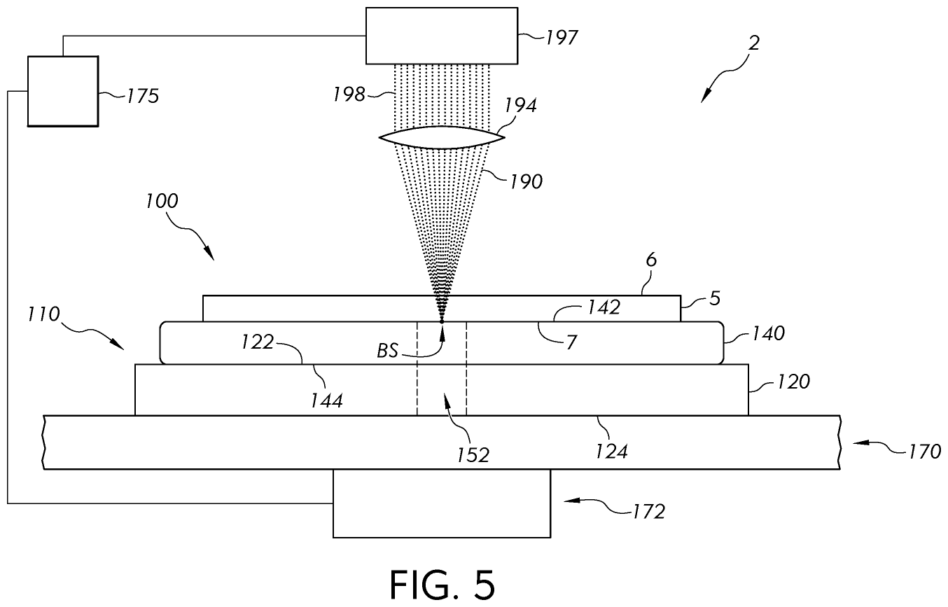

FIG. 5 illustrates an example system 2 for separating the ring structure from a substrate 5 following the formation of perforations that define the inner contour 15A, 15B and outer contour 14A, 14B. The system 2 includes a multilayer stack 100, which may or may not be the same multilayer stack 100 illustrated by FIG. 3. For example, the substrate 5 may remain on the same carrier 110 for both processing steps. In other embodiments, the substrate 5 may be moved to a different carrier 110 for the ring structure separation steps. In the embodiment of FIG. 5, the substrate 5 is positioned on top of the laser disruption element 140, which is positioned on top of the support base 120. In other embodiments, no laser disruption element 140 is provided and the substrate 5 is disposed directly on the support base 120 or some other intermediate layer.

The system 2 further includes a source heating laser beam 198, which may be a CO₂ laser beam, and one or more focusing lenses 194 to focus a heating laser beam 190 to a beam spot BS within the substrate 5. The heating laser source 197 and the one or more focusing lenses 194 define a heating laser beam assembly. One or more actuators 172 may move the worktable 170 the carrier 110 is disposed on worktable 170 such that the beam BS traverses the outer contour 14A, 14B. The system 2 further includes a controller 175 operable to control the one or more actuators 172 and the heating laser source 197.

The heating laser source 197 is operated to form a source heating laser beam 198 that raises the temperature of the material of the substrate 5 at the outer contour 14A, 14B to a temperature sufficient to cause cracking of the substrate 5 via the perforations aligned along the outer contour 14A, 14B. As non-limiting examples, the heating laser source 197 may be operated at a wavelength of about 10600 nm, a power within a range of 50 W to 500 W, a frequency within a range of 5 kHz to 50 kHz, a spot size diameter within a range of 2 mm to 10 mm, and a translation speed within a range of 4 m/min to 30 m/min. For example, the heating source laser 198 may locally raise the temperature of the substrate to a range of 50° C. to 200° C.

One or more passes of the beam spot BS along or adjacent to the outer contour 14A, 14B causes the article 5A′, 5B′ to be separated from the substrate 5A, 5B, as shown in FIGS. 4A and 4B, respectively. It should be understood that the article may take on circular or non-circular shapes, such as elliptical, rectangular and the like. In the examples of FIGS. 4A and 4B, the article 5A′, 5B′ is circular and is defined by an outer edge 11A, 11B where the article 5A′, 5B′ was separated from the substrate 5A, 5B along the outer contour 14A, 14B by heating laser beam 190.

In the next step, the inner portion 16A, 16B of the article 5A′, 5B′ within the inner contour 15A, 15B is removed using the CO₂ laser (or other suitable heating laser). Up until this point of the process, the inner portion 16A, 16B of the article 5A′, 5B′ has not yet been released as there is no room for expansion.

For separation of the inner portion 16A, 16B, the ring area between the outer edge 11A, 11B of the article 5A′, 5B′ and the inner contour 15A, 15B is heated with the heating laser beam 190 such that the ring area will expand by an amount sufficient for removal of the inner portion. FIGS. 4A and 4B illustrate heating lines 20A, 20B on the ring area to provide for ring expansion that allows for removal of the inner portion 16A, 16B. It is noted that the same laser used to separate the article 5A′, 5B′ may be used to heat the ring area.

The properties of the heating laser beam 190 should be such that it does not ablate or otherwise deform the ring area, such as by melting. As a non-limiting example, the heating laser beam may be operated at a power within a range of 50 W to 500 W, a frequency within a range of 5 kHz to 50 kHz, a spot size diameter within a range of 2 mm to 10 mm, and a translation speed within a range of 4 m/min to 30 m/min.

Multiple passes of the heating laser beam 190 of different diameters and placement at different positions within the ring area may be used. The number of passes depends on several factors, such as the thickness of the substrate 5, the type of material, and the dimensions of the desired ring structure. FIGS. 4A and 4B illustrate concentric heating lines 20A, 20B. However, in other embodiments a spiral-shaped heating line may be used. It is noted that the separation should take place before the ring area shrinks again after removal of the heat provided by the heating laser beam 190.

As a non-limiting example, after the inner portion 16A, 16B within the inner contour 15A, 15B has been separated from the article 5A′, 5B, the ring structure(s) 10 may be removed by physically lifting, such as by hand, by a robot or by other device. In some embodiments, the one or more layers of the multilayer stack 100 includes a cavity 152 underneath the inner portion 16A, 16B positioned such that the inner portion 16A, 16B will drop when the expansion of the ring area is big enough or an automated picking directly after the heating process by a robot or other device. The remaining waste portions of the substrate may be removed after the ring structure(s) 10 are removed from the multilayer stack 100.

The result is a ring structure 10 such as shown in FIG. 1.

In contrast to the standard cutting process, the heating is provided on the actual part to be fabricated (i.e., the ring structure 10), and not at a previously perforated position. In comparison to previous drop-out processes where the inner waste portion is heated up, in the methods of the present disclosure the heating needed for expansion of ring structure 10 and removal of inner portion 16A, 16B is much less than is required for drop out of the inner waste portion. Further, the thickness of the substrate may be too large and the width of the ring may be too small to achieve removal of the inner portion 16A, 16B through direct heating the inner portion 16A, 16B without bursting the ring.

A factor for achieving the separation is the ratio of outer diameter dₒ to the inner diameter dᵢ of ring structure 10. For the examples given in FIGS. 2A and 2B, respectively, the ratios are 2.1 and 1.4. Three samples for each of FIGS. 2A and 2B were fabricated as examples. The material thicknesses of the substrates 5A, 5B that were evaluated were 1.6 mm and 3.1 mm, respectively. Although the example of FIG. 2B had almost double the material thickness compared to that of the FIG. 2A, it nonetheless seemed to be easier to separate, perhaps because of its lower diameter ratio. All three trials performed for the design of FIG. 2B provided ring structures that could be separated successfully, whereas for the design of FIG. 2A, only one out of two trials succeeded. Thus, while not wishing to be bound by theory, the ratio of outer diameter dₒ to inner diameter dᵢ may be a factor that is of greater significance than the substrate thickness. The ring cutting may be easier when the ratio of the outer to inner diameter gets smaller. In embodiments, an estimation of the success for a ring cutting may be determined using the following formula, where the ratio of outer diameter dₒ and inner diameter dᵢ should be below a critical value, which is dependent on the material thickness and type of material and which can be determined by routine experimentation. For ring structures having a non-circular shape, it is understood that the inner diameter dᵢ and the outer diameter dₒ correspond to the average diameters of the inner and outer edges of the ring structure, respectively.

$$1 < \frac{outer diameter}{inner diameter} < critical value ( thickness , type )$$

For 1.6 mm thick soda lime glass, the critical value for successful ring cutting appears to be about 2 or slightly above. The ratio of outer diameter dₒ to inner diameter dᵢ must be greater than 1, but it is expected that the ratio must not be too small because some low ratio, thermal stress may be too high and cause the ring structure 10 to break if the ring width w is too small.

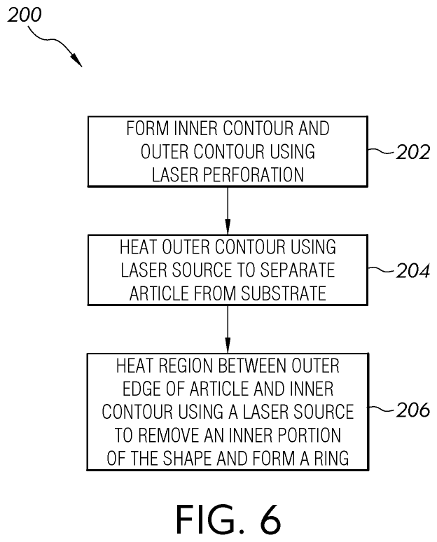

FIG. 6 is a flowchart 200 illustrating an example method of fabricating a ring structure from a substrate. At block 202, an inner contour and an outer contour defining a ring structure are formed within the substrate using a laser perforation process. A laser is used to form a plurality of perforations along the inner contour and the outer contour. These perforations weaken the substrate along the inner contour and the outer contour.

At block 204, an article is separated from the substrate by heating the outer contour with a laser, such as a CO₂ laser. The laser heats the substrate at the outer contour to a temperature to cause controlled cracking along the outer contour. The laser may be provided around one or more passes along the outer contour.

At block 206, a region between the outer edge of the article and the inner contour is heated by a laser, such as a CO₂ laser. Multiple passes of the laser within the region may be provided. Heating of the region causes expansion, which further causes controlled cracking along the inner contour. An inner portion within the inner contour is removed to form the ring structure.

In a first embodiment, a method of forming a ring structure includes forming an inner contour and an outer contour including a plurality of perforations by directing a pulsed laser beam focal line into a substrate at a plurality of locations, the pulsed laser beam focal line generating an induced absorption within a substrate at each of the locations, the induced absorption producing one of the plurality of perforations. The method further includes heating the outer contour with a heating laser beam such that an article separates from the substrate at the outer contour, heating a region of the article between an outer edge of the article and the inner contour with the heating laser beam, and removing an inner portion of the article at the inner contour to form the ring structure.

In a second embodiment, a method according to the first embodiment, wherein the substrate has a thickness within the range of 0.3 mm and 5.0 mm, including endpoints.

In a third embodiment, a method according to the first or second embodiments, wherein the substrate is glass.

In a fourth embodiment, a method according to any one of the first through third embodiments, wherein the heating laser beam is a CO₂ laser beam.

In a fifth embodiment, a method according to any one of the first through fourth embodiments, wherein the heating laser beam has a power of 50 W to 500 W.

In a sixth embodiment, a method according to any one of the first through fifth embodiments, wherein the heating laser beam heats the region to a temperature within the range of 50° C. to 200° C.

In a seventh embodiment, a method according to any one of the first through sixth embodiments, wherein heating the region comprises traversing a focus of the heating laser beam along multiple closed loop passes within the region.

In an eighth embodiment, a method according to any one of the first through seventh embodiments, wherein the heating laser beam is operated at a power within a range of 50 W to 500 W, a frequency within a range of 5 kHz to 50 kHz, a spot size diameter within a range of 2 mm to 10 mm, and a translation speed within a range of 4 m/min to 30 m/min.

In a ninth embodiment, a method according to any one of the first through eighth embodiments, wherein the spacing between perforations is in a range from 4.0 μm to 25 μm.

In a tenth embodiment, a method according to any one of the first through ninth embodiments, wherein the perforations have a diameter in a range from 50 nm to 500 nm.

In an eleventh embodiment, a method according to any one of the first through tenth embodiments, wherein removing the inner portion from the shape comprises applying a force to the inner portion.

In a twelfth embodiment, a system for forming a ring structure includes a carrier having a surface for receiving a substrate, an actuator for translating the carrier in at least two directions, a perforation laser assembly comprising a perforation laser and at least one lens, a heating laser beam assembly comprising a heating laser and at least one focusing lens, and a controller programmed to control the actuator, the perforation laser, and the heating laser to form an inner contour and an outer contour including a plurality of perforations by directing a pulsed laser beam focal line into a substrate at a plurality of locations, the pulsed laser beam focal line generating an induced absorption within the substrate at each of the locations, the induced absorption producing one of the plurality of perforations, and heat the outer contour with a heating laser beam such that an article separates from the substrate at the outer contour, and for heating a region of the article between an outer edge of the article and the inner contour with the heating laser beam such that an inner portion of the article is removable at the inner contour to form the ring structure.

In a thirteenth embodiment, a system according to the twelfth embodiment, wherein the substrate has a thickness within the range of 0.3 mm and 5.0 mm, including endpoints.

In a fourteenth embodiment, as system according to the twelfth or thirteen embodiments, wherein the substrate is glass.

In a fifteenth embodiment, the system according to any one of the twelfth through fourteenth embodiments, wherein the heating laser is a CO₂ laser.

In a sixteenth embodiment, the system according to any one of the twelfth through fifteenth embodiments, wherein the heating laser beam has a power of 50 W to 500 W.

In a seventeenth embodiment, the system according to any one of the twelfth through sixteenth embodiments, wherein the heating laser beam heats the region to a temperature within the range of 50° C. to 200° C.

In an eighteenth embodiment, the system according to any one of the twelfth through seventeenth embodiments, wherein heating the region comprises traversing a focus of the heating laser beam along multiple closed loop passes within the region.

In a nineteenth embodiment, the system according to any one of the twelfth through eighteenth embodiments, wherein the heating laser beam is operated at a power within a range of 50 W to 500 W, a frequency within a range of 5 kHz to 50 kHz, a spot size diameter within a range of 2 mm to 10 mm, and a translation speed within a range of 4 m/min to 30 m/min.

In a twentieth embodiment, the system according to any one of the twelfth through nineteenth embodiments, wherein the carrier comprises a recess such that the inner portion is disposed within the recess.

It is noted that recitations herein of a component of the embodiments being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that one or more of the following claims utilize the term “wherein” as a transitional phrase. For the purposes of defining the embodiments of the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

1. A method of forming a ring structure, the method comprising:
forming an inner contour and an outer contour comprising a plurality of perforations by directing a pulsed laser beam focal line into a substrate at a plurality of locations, the pulsed laser beam focal line generating an induced absorption within the substrate at each of the locations, the induced absorption producing one of the plurality of perforations;
heating the outer contour with a heating laser beam such that an article separates from the substrate at the outer contour;
heating a region of the article between an outer edge of the article and the inner contour with the heating laser beam; and
removing an inner portion of the article at the inner contour to form the ring structure.

2. The method of claim 1, wherein the substrate has a thickness within the range of 0.3 mm and 5.0 mm, including endpoints.

3. The method of claim 1, wherein the substrate is glass.

4. The method of claim 1, wherein the heating laser beam is a CO₂ laser beam.

5. The method of claim 1, wherein the heating laser beam has a power of 50 W to 500 W.

6. The method of claim 1, wherein the heating laser beam heats the region to a temperature within the range of 50° C. to 200° C.

7. The method of claim 1, wherein heating the region comprises traversing a focus of the heating laser beam along multiple closed loop passes within the region.

8. The method of claim 1, wherein the heating laser beam is operated at a power within a range of 50 W to 500 W, a frequency within a range of 5 kHz to 50 kHz, a spot size diameter within a range of 2 mm to 10 mm, and a translation speed within a range of 4 m/min to 30 m/min.

9. The method of claim 1, wherein the spacing between perforations is in a range from 4.0 μm to 25 μm.

10. The method of claim 1, wherein individual perforations of the plurality of perforations have a diameter in a range from 50 nm to 500 nm.

11. The method of claim 1, wherein removing the inner portion from the article comprises applying a force to the inner portion.

12. A system for forming a ring structure comprising:
a carrier having a surface for receiving a substrate;
an actuator for translating the carrier in at least two directions;
a perforation laser assembly comprising a perforation laser source and at least one lens;
a heating laser beam assembly comprising a heating laser source and at least one focusing lens; and
a controller programmed to control the actuator, the perforation laser source, and the heating laser source to:
form an inner contour and an outer contour comprising a plurality of perforations by directing a pulsed laser beam focal line from the perforation laser source into the substrate at a plurality of locations, the pulsed laser beam focal line generating an induced absorption within the substrate at each of the locations, the induced absorption producing one of the plurality of perforations; and
heat the outer contour with a heating laser beam from the heating laser source such that an article separates from the substrate at the outer contour, and
heat a region of the article between an outer edge of the article and the inner contour with the heating laser beam such that an inner portion of the article is removable at the inner contour to form the ring structure.

13. The system of claim 12, wherein the substrate has a thickness within the range of 0.3 mm and 5.0 mm, including endpoints.

14. The system of claim 12, wherein the substrate is glass.

15. The system of claim 12, wherein the heating laser beam is a CO₂ laser.

16. The system of claim 12, wherein the heating laser beam has a power of 50 W to 500 W.

17. The system of claim 12, wherein the heating laser beam heats the region to a temperature within the range of 50° C. to 200° C.

18. The system of claim 12, wherein heating the region comprises traversing a focus of the heating laser beam along multiple circular passes within the region.

19. The system of claim 12, wherein the heating laser beam is operated at a power within a range of 50 W to 500 W, a frequency within a range of 5 kHz to 50 kHz, a spot size diameter within a range of 2 mm to 10 mm, and a translation speed within a range of 4 m/min to 30 m/min.

20. The system of claim 12, wherein the carrier comprises a recess such that the inner portion, upon separation, is disposed within the recess.
